(19) United States
(12) Patent Application Publication
(10) Pub. No.: US 2002/0184336 A1
(43) Pub. Date: Dec. 5, 2002

(54) Occurrence description schemes for multimedia content

(76) Inventor: Hawley K. Rising III, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/090,557

(22) Filed: Mar. 1, 2002

Related U.S. Application Data
(60) Provisional application No. 60/273,216, filed on Mar. 1, 2001.

(51) Int. Cl. G06F 3/00; H04N 5/445; G06F 13/00; G06F 15/16

(52) U.S. Cl. 709/217; 709/219; 725/53

(57) ABSTRACT

An occurrence description scheme that describes an occurrence of a semantic entity in multimedia content is encoded into a content description for the content. The occurrence description scheme is decoded from the content description and used by an application to search, filter or browse the content when a full structural or semantic description of the content is not required.

### RELATED APPLICATIONS

This application is related to and claims the benefit of U.S. Provisional Patent application serial No. 60/273,216, filed Mar. 1, 2001, which is hereby incorporated by reference.

### FIELD OF THE INVENTION

This invention relates generally to the description of multimedia content, and more particularly to occurrence description schemes for multimedia content.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2001, Sony Electronics, Inc., All Rights Reserved.

### BACKGROUND OF THE INVENTION

Digital multimedia information is becoming widely distributed through broadcast transmission, such as digital television signals, and interactive transmission, such as the Internet. The information may be in still images, audio feeds, or video data streams. However, the availability of such a large volume of information has led to difficulties in identifying content that is of particular interest to a user. Various organizations have attempted to deal with the problem by providing a description of the information that can be used to search, filter and/or browse to locate the particular content. The Moving Picture Experts Group (MPEG) has promulgated a Multimedia Content Description Interface standard, commonly referred to as MPEG-7 to standardize the content descriptions for multimedia information. In contrast to preceding MPEG standards such as MPEG-1 and MPEG-2, which define coded representations of audio-visual content, an MPEG-7 content description describes the structure and semantics of the content and not the content itself.

Using a movie as an example, a corresponding MPEG-7 content description would contain “descriptors,” which are components that describe the features of the movie, such as scenes, titles for scenes, shots within scenes, and time, color, shape, motion, and audio information for the shots. The content description would also contain one or more “description schemes,” which are components that describe relationships among two or more descriptors, such as a shot description scheme that relates together the features of a shot. A description scheme can also describe the relationship among other description schemes, and between description schemes and descriptors, such as a scene description scheme that relates the different shots in a scene, and relates the title feature of the scene to the shots.

MPEP-7 uses a Data Definition Language (DDL) to define descriptors and description schemes, and provides a core set of descriptors and description schemes. The DDL definitions for a set of descriptors and description schemes are organized into “schemas” for different classes of content. The DDL definition for each descriptor in a schema specifies the syntax and semantics of the corresponding feature. The DDL definition for each description scheme in a schema specifies the structure and semantics of the relationships among its children components, the descriptors and description schemes. The DDL may be used to modify and extend the existing description schemes and create new description schemes and descriptors.

The MPEG-7 DDL is based on the XML (extensible markup language) and the XML Schema standards. The descriptors, description schemes, semantics, syntax, and structures are represented with XML elements and XML attributes. Some of the XML elements and attributes may be optional.

The MPEG-7 content description for a particular piece of content is an instance of an MPEG-7 schema; that is, it contains data that adheres to the syntax and semantics defined in the schema. The content description is encoded in an “instance document” that references the appropriate schema. The instance document contains a set of “descriptor values” for the required elements and attributes defined in the schema, and for any necessary optional elements and/or attributes. For example, some of the descriptor values for a particular movie might specify that the movie has three scenes, with scene one having six shots, scene two having five shots, and scene three having ten shots. The instance document may be encoded in a textual format using XML, or in a binary format, such as the binary format specified for MPEG-7 data, known as “BiM,” or a mixture of the two formats.

The instance document is transmitted through a communication channel, such as a computer network, to another system that uses the content description data contained in the instance document to search, filter and/or browse the corresponding content data stream. Typically, the instance document is compressed for faster transmission. An encoder component may both encode and compress the instance document or the functions may be performed by different components. Furthermore, the instance document may be generated by one system and subsequently transmitted by a different system. A corresponding decoder component at the receiving system uses the referenced schema to decode the instance document. The schema may be transmitted to the decoder separately from the instance document, as part of the same transmission, or obtained by the receiving system from another source. Alternatively, certain schemas may be incorporated into the decoder.

Description schemes directed to describing content generally relate to either the structure or the semantics of the content. Structure-based description schemes are typically defined in terms of segments that represent physical spatial and/or temporal features of the content, such as regions, scenes, shots, and the relationships among them. The details of the segments are typically described in terms of signals, e.g., color, texture, shape, motion, etc. In some instances, a segment description may also contain some limited semantic information. The full semantic description of the content is provided by the semantic-based description schemes. These description schemes describe the content in terms of what it depicts, such as objects, people, events, and their relationships. A typical schema contains both types of description schemes. Generally, a content description is developed by first specifying the structure of the content and then adding the semantic information to the structure. However, applications that are interested only in the semantics of the content at certain points do not need the full structural description.

### SUMMARY OF THE INVENTION

An occurrence description scheme that describes an occurrence of a semantic entity in multimedia content is encoded into a content description for the content. The occurrence description scheme is decoded from the content description and used by an application to search, filter or browse the content when a full structural or semantic description of the content is not required.

### BRIEF DESCRIPTION OF THE DRAWINGS

FIG. 1A is a diagram illustrating a overview of the operation of an embodiment of a multimedia content description system according to the invention;

FIG. 1B is a diagram illustrating description schemes in a content description according to the embodiment of FIG. 1A;

FIG. 2 is a diagram of a computer environment suitable for practicing the invention; and

FIGS. 3A-B are flow diagrams of methods to be performed by a computer in operating as illustrated in FIGS. 1A-B.

### DETAILED DESCRIPTION OF THE INVENTION

In the following detailed description of embodiments of the invention, reference is made to the accompanying drawings in which like references indicate similar elements, and in which is shown, by way of illustration, specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

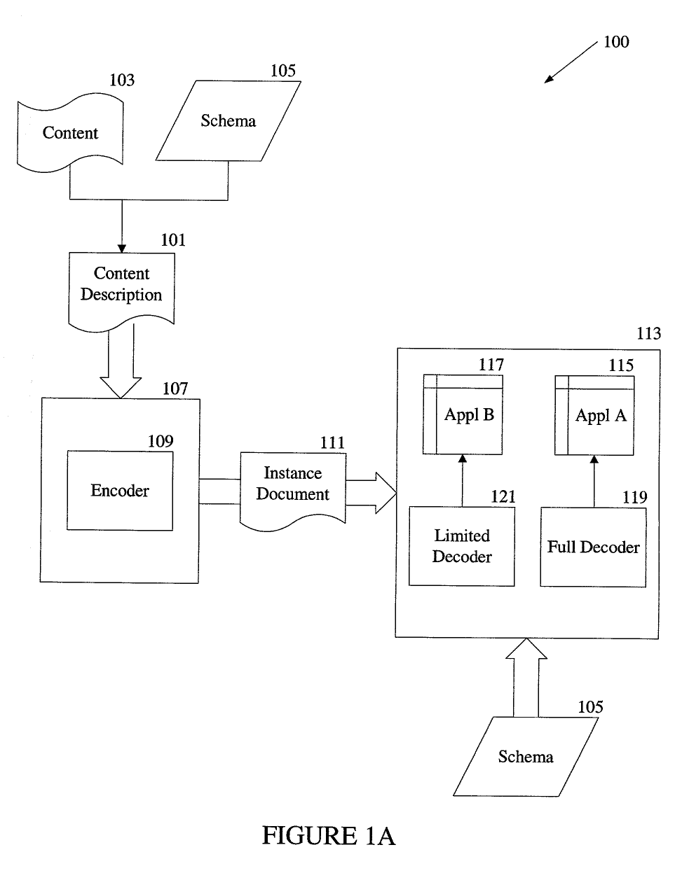

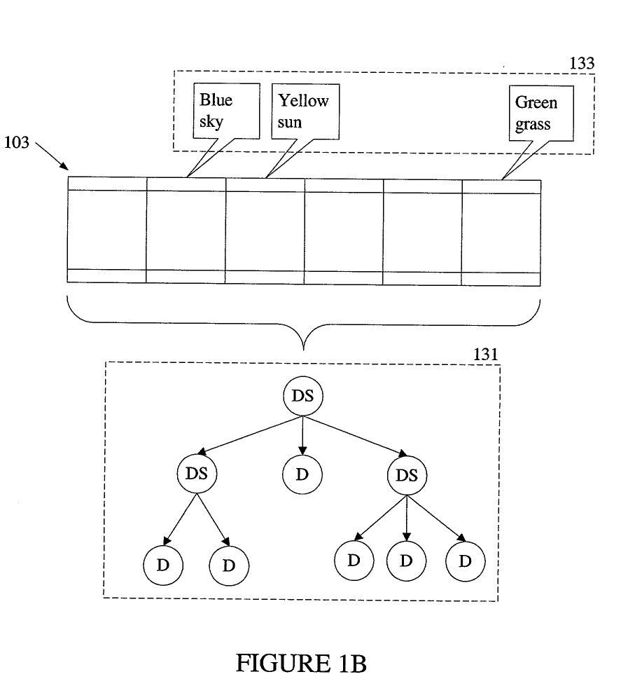

Beginning with an overview of the operation of the invention, FIG. 1A illustrates one embodiment of a multimedia content description system 100. A content description 101 is created for an instance of content 103 with reference to a schema 105. The schema 105 defines description schemes that describe the full structure and semantic features of content. In addition, the schema 105 defines description schemes that describe the semantic entities of the content at certain points, i.e., the occurrence of a semantic entity at a point in time or location. Thus, as illustrated in FIG. 1B, the content description 101 contains structure and semantic description schemes 131 and occurrence description schemes 133. The content description 101 is encoded into an instance document 111 using an encoder 109 on a server 107. The instance document 111 is transmitted by the server 107 to a client system 113.

The client system 113 executes two applications 115, 117 that use the content description 101 to search, filter and/or browse the corresponding content data stream. Application A 115 requires access to the structure and full semantic information about the content and so employs a full decoder 119 that is capable of processing structure and semantic description schemes 131 in the instance document 111. On the other hand, application B 117 requires access to only limited semantic information about the content and so employs a limited decoder 121 that understands only the occurrence description schemes 133 in the instance document 111.

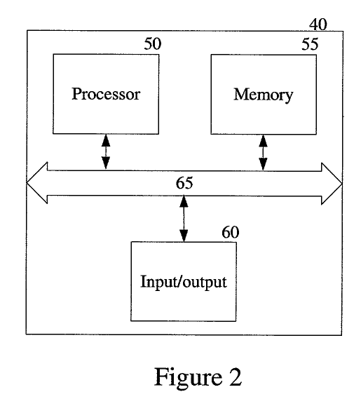

The following description of FIG. 2 is intended to provide an overview of computer hardware and other operating components suitable for implementing the invention, but is not intended to limit the applicable environments. FIG. 2 illustrates one embodiment of a computer system suitable for use as the server and/or client system of FIG. 1A. The computer system 40 includes a processor 50, memory 55 and input/output capability 60 coupled to a system bus 65. The memory 55 is configured to store instructions which, when executed by the processor 50, perform the methods described herein. The memory 55 may also store the access units. Input/output 60 provides for the delivery and receipt of the access units. Input/output 60 also encompasses various types of computer-readable media, including any type of storage device that is accessible by the processor 50. One of skill in the art will immediately recognize that the term “computer-readable medium/media” further encompasses a carrier wave that encodes a data signal. It will also be appreciated that the system 40 is controlled by operating system software executing in memory 55. Input/output and related media 60 store the computer-executable instructions for the operating system and methods of the present invention as well as the access units. The encoder 109 and decoders 119, 121 shown in FIG. 1A may be separate components coupled to the processor 50, or may embodied in computer-executable instructions executed by the processor 50. In one embodiment, the computer system 40 may be part of, or coupled to, an ISP (Internet Service Provider) through input/output 60 to transmit or receive the access units over the Internet. It is readily apparent that the present invention is not limited to Internet access and Internet web-based sites; directly coupled and private networks are also contemplated.

It will be appreciated that the computer system 40 is one example of many possible computer systems that have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

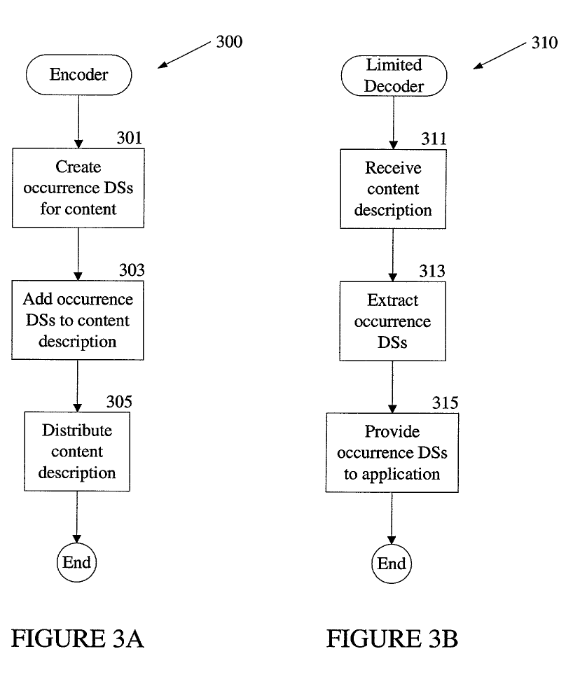

Next, the particular methods of the invention are described in terms of computer software with reference to flow diagrams in FIGS. 3A and 3B that illustrate the processes performed by computers to provide the encoder 109 and the limited decoder 121 in FIG. 1A, respectively. The methods constitute computer programs made up of computer-executable instructions illustrated as blocks (acts) 301 until 305 in FIG. 3A, and blocks 311 until 315 in FIG. 3B. Describing the methods by reference to a flow diagram enables one skilled in the art to develop such programs including such instructions to carry out the methods on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer processes may be incorporated into the methods illustrated in FIGS. 3A and 3B without departing from the scope of the invention and that no particular order is implied by the arrangement of blocks shown and described herein.

An encoder method 300 illustrated in FIG. 3A may be incorporated into a standard content description encoder executing on a server or may operate as a separate process. One or more occurrence description schemes for multimedia content are created at block 301 and added into the content description for the multimedia content at block 303. The resulting content description may contain description schemes that describe the full structure and semantics of the content in addition to the occurrence description schemes. At block 305, the content description is distributed to another computer for subsequent distribution to client computers, or directly to the client computers when the encoder method is executing on the server that also distributes the content description.

On a client computer, a limited decoder method 310 as illustrated in FIG. 3B receives the content description at block 311 and extracts the occurrence description schemes at block 313. The method 310 provides the appropriate occurrence description scheme to an application executing on the client computer that is searching, filtering or browsing the corresponding content at block 315.

The MPEG-7, the occurrence description scheme may be defined using a MediaOccurrence description scheme (DS) element in SemanticBase DS. The MediaOccurrence DS represents one appearance of an object or an event in the media with a media locator and/or a set of descriptor values. The MediaOccurrence DS provides access to the same media information as the Segment DS, but without the hierarchy and without extra temporal and spatial information for applications that need only the object/event location in the media, and the descriptor values at that location. The corresponding MPEG-7 DDL for the MediaOccurrence DS may be

<complexType name=“MediaOccurrenceType”>

<element name=“MediaLocator”
type=“mpeg7:MediaLocatorType”

minOccurs=“1” maxOccurs=“1”/>

<element name=“Descriptor”
type=“mpeg7:DescriptorCollectionType”

minOccurs=“0” maxOccurs=“1”/>

<attribute name=“type” type=“mpeg7:mediaOccurrenceType”

use=“required“ default=“perceivable”/>

</complexType>,

where the mediaOccurrenceType data type is defined as

<simpleType name=“mediaOccurrenceType” base=“string”

derivedBy=“retriction”>

<enumeration value=“perceivable”/>
<enumeration value=“symbol”/>

</simpleType>.

The mediaOccurrenceType data type enumerates the specific type of occurrence of the semantic entity in the media. The allowed types are “perceivable” and “symbol.” Perceivable is used for a semantic entity that is perceivable in the media with a spatial and/or temporal extent. Symbol is used for a semantic entity that is symbolized in the media with a spatial and/or temporal extent. Thus, a person is perceivable in a picture but is symbolically represented in a textual description of the picture. The MediaLocator element specifies a location in the media for the physical instance of the semantic object/event. The Descriptor element specifies set of descriptors that describe the features of the media at the location pointed to by MediaLocator. Each descriptor field defines the properties of a particular feature at that location. For instance, if the Descriptor element contains a color histogram descriptor and a shape descriptor, the values in these descriptors are the values in the media at that point. If MediaLocator points, for example, to a part of a scene taking place in a red room, one expects the color histogram values to reflect the red color.

The MPEG-7 DDL for the DescriptorCollectionType data type may be

<complexType name=“DescriptorCollectionType”>

<complexContent>

<extension base=“mpeg7:CollectionType”>

<sequence>
<element name=“Descriptor”
type=“mpeg7:ExtendedDType”

minOccurs=“0” maxOccurs=“unbounded”/>

</sequence>

</extension>

</complexContent>

</complexType>

where the ExtendedDType data type defines a set of attribute value pairs in which the value field may be any of the standard MPEG-7 descriptor data types, plus the basic data types from XML. Use of the ExtendedDType data type reduces the amount of DDL that would otherwise be written to define a DescriptorCollection.

An occurrence description scheme and corresponding decoder for multimedia content descriptions has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application with respect to MPEG-7 is meant to include all environments that provide content descriptions. Therefore, it is manifestly intended that this invention be limited only by the following claims and equivalents thereof.

What is claimed is:

1. A computerized method comprising:
receiving a content description for multimedia content, the content description comprising an occurrence description scheme describing an occurrence of a semantic entity in the content; and
extracting the occurrence description scheme from the content description.

2. The computerized method of claim 1, wherein the content description further comprises a full semantic description scheme for the semantic entry.

3. The computerized method of claim 1 further comprising:
providing the occurrence description scheme to an application that evaluates the multimedia content.

4. The computerized method of claim 3, wherein the application is selected from the group consisting of searching, filtering, and browsing applications.

5. The computerized method of claim 1, wherein the content description complies with the MPEG-7 standard and the occurrence description scheme is represented by a MediaOccurrence description scheme.

6. The computerized method of claim 1 further comprising:
creating the content description from the occurrence description scheme.

7. The computerized method of claim 6 further comprising:
distributing the content description through a communications media.

8. A computerized method comprising:
creating a content description for multimedia content, the content description comprising an occurrence description scheme describing an occurrence of a semantic entity in the multimedia content.

9. The computerized method of claim 8, wherein the content description complies with the MPEG-7 standard and the occurrence description scheme is represented by a MediaOccurrence description scheme.

10. The computerized method of claim 8 further comprising:
distributing the content description through a communication media.

11. A computer-readable medium having executable instructions to cause a processor to perform a method comprising:
receiving a content description for multimedia content, the content description comprising an occurrence description scheme describing an occurrence of a semantic entity in the content; and
extracting the occurrence description scheme from the content description.

12. The computer-readable medium of claim 11, wherein the content description further comprises a full semantic description scheme for the semantic entry.

13. The computer-readable medium of claim 11, wherein the method further comprises:
providing the occurrence description scheme to an application that evaluates the multimedia content.

14. The computer-readable medium of claim 13, wherein the application is selected from the group consisting of searching, filtering, and browsing applications.

15. The computer-readable medium of claim 11, wherein the content description complies with the MPEG-7 standard and the occurrence description scheme is represented by a MediaOccurrence description scheme.

16. The computer-readable medium of claim 11, wherein the method further comprises:
creating the content description from the occurrence description scheme.

17. The computer-readable medium of claim 16, wherein the method further comprises:
distributing the content description through a communications media.

18. A computer-readable medium having executable instructions to cause a computer to perform a method comprising:
creating a content description for multimedia content, the content description comprising an occurrence description scheme describing an occurrence of a semantic entity in the multimedia content.

19. The computer-readable medium of claim 18, wherein the content description complies with the MPEG-7 standard and the occurrence description scheme is represented by a MediaOccurrence description scheme.

20. The computer-readable medium of claim 18, wherein the method further comprises:
distributing the content description through a communication media.

21. A system comprising:
a processor coupled to a bus;
a memory coupled to the processor through the bus;
a communications interface coupled to the processor through the bus, and further coupled to a communications medium; and
a limited decode process executed by the processor from the memory to cause the processor to receive, through the communications interface, a content description for multimedia content, the content description comprising an occurrence description scheme describing an occurrence of a semantic entity in the content, and to extract the occurrence description scheme from the content description.

22. The system of claim 21, wherein the limited decode process further causes the processor to provide the occurrence description scheme to an application that evaluates the multimedia content.

23. The system of claim 22, wherein the application is selected from the group consisting of searching, filtering, and browsing applications.

24. The system of claim 21, wherein the content description complies with the MPEG-7 standard and the occurrence description scheme is represented by a MediaOccurrence description scheme.

25. The system of claim 21 further comprising:
a decode process executed by the processor from the memory to cause the processor to receive, through the communications interface, the content description for multimedia content, the content description further comprising a full semantic description scheme for the semantic entry, and to extract the full semantic description scheme from the content description.

26. A system comprising:
a processor coupled to a bus;
a memory coupled to the processor through the bus; and
an encode process executed by the processor from the memory to cause the processor to create a content description for multimedia content, the content description comprising an occurrence description scheme describing an occurrence of a semantic entity in the multimedia content.

27. The system of claim 26, wherein the content description complies with the MPEG-7 standard and the occurrence description scheme is represented by a MediaOccurrence description scheme.

28. The system of claim 26, wherein the system further comprises a communications interface coupled to the processor through the bus and further coupled to a communications medium, and the encode process further causes the processor to distribute the content description through the communications interface.
